(19) United States
(12) Patent Application Publication
(10) Pub. No.: US 2023/0313886 A1
(43) Pub. Date: Oct. 5, 2023

(54) DRIVE APPARATUS

(71) Applicant: NIDEC CORPORATION, Kyoto (JP)

(72) Inventors: Hideaki MATSUO, Kyoto (JP); Mitsuhiro HARA, Kyoto (JP); Keisuke ASO, Kyoto (JP); Naohiro WADA, Kyoto (JP); Yusuke MAKINO, Kyoto (JP)

(21) Appl. No.: 18/174,650

(22) Filed: Feb. 27, 2023

(30) Foreign Application Priority Data
Mar. 31, 2022 (JP) 2022-061133

(51) Int. Cl. F16H 63/34

(52) U.S. Cl. CPC F16H 63/3466; F16H 63/3425

(57) ABSTRACT

A drive apparatus includes a housing including a motor, a power transmission unit, a parking mechanism, and a gear accommodation portion. The parking mechanism includes a parking gear, a pawl, a transmission unit, and a sleeve. The transmission unit includes a cam rod and a cam attached to the cam rod to operate the pawl. The cam is guided by the sleeve. The gear accommodation portion has first and second housing members, a breather, and a dividing wall partitioning a space where the breather opens inside the gear accommodation portion. The second housing member is provided with a holding recess that opens to a first side in an axial direction and holds the sleeve. The first housing member is provided with a retaining wall that covers a surface facing a second side in the axial direction of the sleeve. The retaining wall is a part of the dividing wall.

### CROSS-REFERENCE TO RELATED APPLICATIONS

The present invention claims priority under 35 U.S.C. § 119 to Japanese Patent Application No. 2022-061133 filed on Mar. 31, 2022, the entire content of which is incorporated herein by reference.

### FIELD OF THE INVENTION

The present invention relates to a drive apparatus.

### BACKGROUND

A parking mechanism is mounted on a drive apparatus that drives a vehicle. There is a vehicle parking device that pushes out a parking pawl to the parking gear side by moving a cam member with a parking rod to lock the parking gear and the parking pawl. There is a structure in which the cam member is guided by a sleeve member.

Since the sleeve of the conventional structure is fixed to an inner surface of a housing by a bolt or the like, there has been a problem that not only the number of parts increases but also an assembly process becomes complicated.

### SUMMARY

One aspect of an exemplary drive apparatus of the present invention includes a motor that rotates about a central axis, a power transmission unit that transmits power of the motor, a parking mechanism, and a housing having a gear accommodation portion that accommodates the power transmission unit and the parking mechanism. The power transmission unit includes at least one shaft. The parking mechanism includes a parking gear provided on an outer peripheral surface of the shaft, a parking pawl provided with a protrusion that meshes with the parking gear, a transmission unit that transmits power to the parking pawl, and a tubular sleeve. The transmission unit includes a cam rod that is driven along an axial direction of the central axis, and a cam that is attached to the cam rod to operate the parking pawl. The cam is guided by the sleeve. The gear accommodation portion is provided with a breather that allows the inside and the outside of the gear accommodation portion to communicate with each other, and a dividing wall portion that partitions a space where the breather opens inside the gear accommodation portion. The gear accommodation portion includes a first housing member and a second housing member arranged on a first side in the axial direction of the first housing member and connected to the first housing member. The second housing member is provided with a holding recess that opens to the first side in the axial direction and holds the sleeve. The first housing member is provided with a retaining wall portion that covers a surface facing a second side in the axial direction of the sleeve. The retaining wall portion is a part of the dividing wall portion.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view of a drive apparatus according to an preferred embodiment;

FIG. 2 is a conceptual view of the drive apparatus according to the preferred embodiment;

FIG. 3 is a front view of a gear accommodation portion according to the preferred embodiment;

FIG. 4 is a front view of a breather chamber according to the preferred embodiment;

FIG. 5 is a partial cross-sectional view of the drive apparatus according to the preferred embodiment;

FIG. 6 is a perspective view of a parking mechanism according to the preferred embodiment;

FIG. 7 is a partial cross-sectional view of the drive apparatus according to the preferred embodiment; and

FIG. 8 is an exploded perspective view of a sleeve and a housing according to the preferred embodiment.

### DETAILED DESCRIPTION

Description below will be made with a direction of gravity being specified based on a positional relationship in a case where a drive apparatus 1 is mounted in a vehicle located on a horizontal road surface. Further, in the drawings, an XYZ coordinate system is shown appropriately as a three-dimensional orthogonal coordinate system.

In the XYZ coordinate system, a Z-axis direction corresponds to a vertical direction (i.e., an up-down direction), and a +Z direction points upward (i.e., in a direction opposite to the direction of gravity), while a −Z direction points downward (i.e., in the direction of gravity). Further, an X-axis direction is a direction orthogonal to the Z-axis direction and shows a front-rear direction of a vehicle in which the drive apparatus 1 is mounted. In an embodiment below, a side (+X side) toward which an arrow in an X axis is directed is a front side in the vehicle, and a side (−X side) opposite to the side toward which the arrow in the X axis is directed is a rear side in the vehicle. A Y-axis direction is a direction orthogonal to both the X-axis direction and the Z-axis direction, and is a width direction (left-right direction) of the vehicle. In the embodiment below, a side (+Y side) toward which an arrow in a Y axis is directed is a left side in the vehicle, and a side (−Y side) opposite to the side toward which the arrow in the Y axis is directed is a right side in the vehicle. Each of the front-rear direction and the left-right direction is a horizontal direction orthogonal to the vertical direction.

In description below, unless otherwise specified, a direction (Y-axis direction) parallel to a central axis J1 of a motor 2 is simply referred to as an “axial direction”, a radial direction around the central axis J1 is simply referred to as a “radial direction”, and a circumferential direction around the central axis J1, that is, a direction around the central axis J1 is simply referred to as a “circumferential direction”. The “parallel” mentioned above includes both “parallel” and “substantially parallel”. Furthermore, in description below, in the axial direction of the central axis J1, the +Y direction may be simply referred to as a first side in the axial direction, and the −Y direction may be simply referred to as a second side in the axial direction.

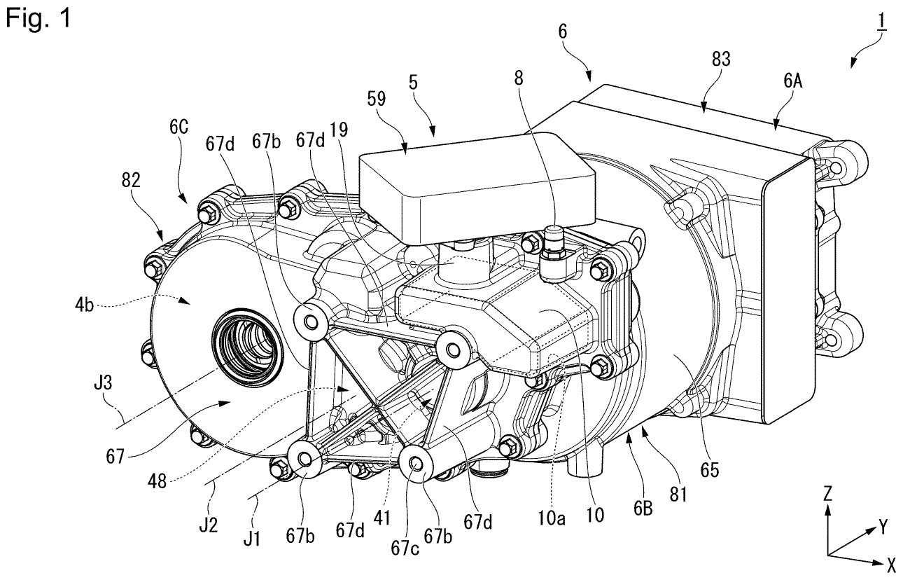

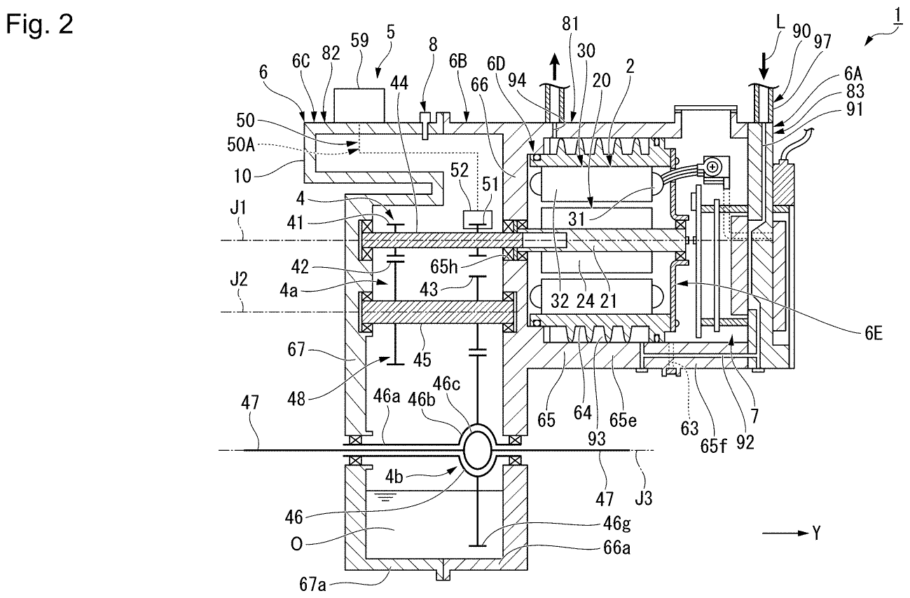

FIG. 1 is a perspective view of the drive apparatus 1 of the present preferred embodiment. FIG. 2 is a conceptual view of the drive apparatus 1 of the present preferred embodiment.

The drive apparatus 1 according to the present preferred embodiment is mounted in a vehicle having a motor as a power source, such as a hybrid vehicle (HEV), a plug-in hybrid vehicle (PHV), and an electric vehicle (EV), and is used as a power source of the vehicle.

As shown in FIG. 2, the drive apparatus 1 includes the motor 2, a power transmission unit 4, a parking device 5, an inverter 7, and a housing 6. The housing 6 accommodates the motor 2, the power transmission unit 4, the parking device 5, and the inverter 7. In the housing 6, the motor 2, the power transmission unit 4, and the inverter 7 are arranged on the central axis J1.

The motor 2 of the present preferred embodiment is an inner rotor type three-phase AC motor. The motor 2 has both a function as an electric motor and a function as a generator. Note that a configuration of the motor 2 is not limited to the present preferred embodiment, and may be, for example, an AC motor of four or more phases.

The motor 2 rotates about the central axis J1 extending in the horizontal direction. The motor 2 includes a rotor 20 and a stator 30 facing the rotor 20 in the radial direction. The motor 2 of the present preferred embodiment is an inner rotor type motor in which the rotor 20 is arranged inside the stator 30.

The rotor 20 rotates about the central axis J1. The rotor 20 includes a first shaft 21, a rotor core 24 fixed to an outer peripheral surface of the first shaft 21, and a rotor magnet (not shown) fixed to the rotor core 24. Torque of the rotor 20 is transmitted to the power transmission unit 4. The first shaft 21 extends along the axial direction about the central axis J1. Both end portions of the first shaft 21 are rotatably supported by the housing 6 through a bearing.

The stator 30 is held by the housing 6. The stator 30 encloses the rotor 20 from the outer side in the radial direction. The stator 30 includes an annular stator core 32 around the central axis J1, a coil 31 mounted on the stator core 32, and an insulator (not shown) interposed between the stator core 32 and the coil 31. The stator core 32 has a plurality of magnetic pole teeth (not shown) toward the inside in the radial direction from an inner peripheral surface of an annular yoke. A coil wire is arranged between magnetic pole teeth. A coil wire located in a gap between adjacent magnetic pole teeth constitutes the coil 31. The insulator is made from an insulating material.

The inverter 7 is electrically connected to the motor 2. The inverter 7 is connected to a battery (not shown) mounted on a vehicle to convert direct current supplied from the battery into alternating current and supplies the alternating current to the motor 2. Further, the inverter 7 controls the motor 2. The inverter 7 of the present preferred embodiment is arranged on a first side in the axial direction (+Y side) with respect to the motor 2. According to the present preferred embodiment, the drive apparatus 1 can be downsized in the radial direction as compared with a case where the inverter 7 is arranged outside in the radial direction of the motor 2.

As shown in FIG. 2, the power transmission unit 4 is arranged on a second side in the axial direction (−Y side) with respect to the motor 2. The power transmission unit 4 is connected to the rotor 20, transmits power of the motor 2, and outputs the power to an output shaft 47. The power transmission unit 4 includes a reduction gear 4a and a differential gear 4b. That is, the drive apparatus 1 includes the reduction gear 4a and the differential gear 4b.

Torque output from the motor 2 is transmitted to the differential gear 4b via the reduction gear 4a. The reduction gear 4a is a speed reducer of a parallel-axis gearing type, in which rotational axes of gears are arranged in parallel with each other. The differential gear 4b transmits the same torque to left and right wheels while absorbing a speed difference between the left and right wheels when a vehicle turns.

The reduction gear 4a includes a second shaft (shaft) 44, a first gear 41, and a second gear portion 48. That is, the drive apparatus 1 includes the second shaft 44, the first gear 41, and the second gear portion 48. Further, the second gear portion 48 includes a third shaft 45, a large-diameter gear 42, and a small-diameter gear 43. The differential gear 4b includes a third gear 46g, a differential case 46, and a differential mechanism portion 46c arranged inside the differential case 46. That is, the power transmission unit 4 includes a plurality of the gears 41, 42, 43, and 46g.

The second shaft 44 extends in the axial direction about the central axis J1. The second shaft 44 is arranged coaxially with the first shaft 21. The second shaft 44 is connected to an end portion on the second side in the axial direction (−Y side) of the first shaft 21 at an end portion on the first side in the axial direction (+Y side). The second shaft 44 rotates about the central axis J1 together with the first shaft 21. That is, the second shaft 44 rotates around the central axis J1 by power of the motor 2.

The first gear 41 is provided on an outer peripheral surface of the second shaft 44. The first gear 41 rotates about the central axis J1 together with the second shaft 44.

Portions (the third shaft 45, the large-diameter gear 42, and the small-diameter gear 43) of the second gear portion 48 are fixed to each other. The second gear portion 48 rotates about an intermediate axis J2 parallel to the central axis J1. The third shaft 45 extends in the axial direction about the intermediate axis J2. The large-diameter gear 42 and the small-diameter gear 43 are arranged side by side in the axial direction. The small-diameter gear 43 is arranged closer to the motor 2 side (that is, the first side in the axial direction) than the large-diameter gear 42 in the axial direction. The large-diameter gear 42 and the small-diameter gear 43 are provided on an outer peripheral surface of the third shaft 45.

The large-diameter gear 42 meshes with the first gear 41. By the above, the large-diameter gear 42 rotates about the intermediate axis J2. The small-diameter gear 43 has a diameter smaller than that of the large-diameter gear 42. The small-diameter gear 43 rotates about the intermediate axis J2 together with the large-diameter gear 42.

The third gear 46g meshes with the small-diameter gear 43. The third gear 46g rotates about a differential axis J3 parallel to the central axis J1. Torque output from the motor 2 is transmitted to the third gear 46g via the reduction gear 4a. The third gear 46g is fixed to the differential case 46.

The differential case 46 includes a case portion 46b that accommodates the differential mechanism portion 46c in the inside, and a differential case shaft 46a that protrudes to the first side and the second side in the axial direction with respect to the case portion 46b. The differential case shaft 46a has a tubular or substantially tubular shape extending along the axial direction around the differential axis J3. The third gear 46g is provided on an outer peripheral surface of the differential case shaft 46a. The differential case shaft 46a rotates about the differential axis J3 together with the third gear 46g.

A pair of the output shafts 47 are connected to the differential gear 4b. A pair of the output shafts 47 protrude from the differential case 46 of the differential gear 4b to the first side and the second side in the axial direction. The output shaft 47 is arranged inside the differential case shaft 46a. The output shaft 47 is rotatably supported on an inner peripheral surface of the differential case shaft 46a via a bearing.

Torque output from the motor 2 is transmitted to the third gear 46g of the differential gear 4b via the second shaft 44, the first gear 41, the large-diameter gear 42, the third shaft 45, and the small-diameter gear 43 of the reduction gear 4a, and is output to the output shaft 47 via the differential mechanism portion 46c of the differential gear 4b. A plurality of the gears 41, 42, 43, and 46g of the power transmission unit 4 transmit power of the motor 2 through the second shaft 44, the third shaft 45, and the differential case shaft 46a in this order.

The housing 6 includes an inverter holder 6A, a housing body 6B, a gear cover 6C, a water jacket 6D, and a bearing holder 6E. The inverter holder 6A, the housing body 6B, the gear cover 6C, the water jacket 6D, and the bearing holder 6E are separate members. The inverter holder 6A is arranged on the first side in the axial direction (+Y side) of the housing body 6B. The gear cover 6C is arranged on the second side in the axial direction (−Y side) of the housing body 6B. The water jacket 6D and the bearing holder 6E are arranged inside the housing body 6B.

The housing body 6B accommodates the motor 2 and opens to the first side in the axial direction (+Y side). The housing body 6B includes a cylindrical outer tube portion 65 around the central axis J1, a partition wall portion 66 arranged on the second side in the axial direction (−Y side) of the outer tube portion 65 and covering an opening on the second side in the axial direction of the outer tube portion 65, and a first gear peripheral wall portion 66a extending from an outer edge of the partition wall portion 66 to the second side in the axial direction (−Y side).

Note that, in the present description, the partition wall portion 66 means the entire wall portion extending along a plane orthogonal to the axial direction between the motor 2 and the power transmission unit 4. The partition wall portion 66 in the present description includes not only a portion that separates spaces accommodating the motor 2 and the power transmission unit 4 from each other in the housing 6, but also a portion that extends outward in the radial direction with respect to the space accommodating the motor 2 or the power transmission unit 4.

The partition wall portion 66 is provided with a shaft insertion hole 65h. In the shaft insertion hole 65h, a bearing that supports the first shaft 21, a bearing that supports the second shaft 44, and a seal member are arranged. The first shaft 21 and the second shaft 44 are connected to each other inside the shaft insertion hole 65h. The seal member is arranged between two bearings in the axial direction. The seal member seals a space between an inner peripheral surface of the shaft insertion hole 65h and an outer peripheral surface of the second shaft 44. Note that the first shaft 21 and the second shaft 44 may be one member.

The outer tube portion 65 of the housing body 6B includes a motor peripheral wall portion 65e that surrounds the motor 2 from the outer side in the radial direction, and an inverter peripheral wall portion 65f that surrounds a part of the inverter 7 from the outer side in the radial direction. The motor peripheral wall portion 65e supports the stator 30 via the water jacket 6D. The inverter peripheral wall portion 65f is located on the first side in the axial direction (+Y side) of the motor peripheral wall portion 65e.

The gear cover 6C is arranged on the second side in the axial direction (−Y side) of the housing body 6B. The gear cover 6C includes an opposing wall portion 67 facing the partition wall portion 66 and a second gear peripheral wall portion 67a extending from an outer edge of the opposing wall portion 67 to the first side in the axial direction (+Y side). An end surface on the first side in the axial direction (+Y side) of the second gear peripheral wall portion 67a is fastened to an end surface on the second side in the axial direction (−Y side) of the first gear peripheral wall portion 66a of the housing body 6B.

The inverter holder 6A holds the inverter 7. The inverter holder 6A covers an opening on the first side in the axial direction (+Y side) of the outer tube portion 65 of the housing body 6B. The inverter holder 6A is provided with a first flow path portion 91 for cooling the inverter 7.

The water jacket 6D has an inner tube portion 64 having a tubular or substantially tubular shape around the central axis J1. The inner tube portion 64 surrounds the stator 30 from the outer side in the radial direction. An inner diameter of the inner tube portion 64 substantially coincides with an outer diameter of the stator core 32. An inner peripheral surface of the inner tube portion 64 is in contact with an outer peripheral surface of the stator 30. Further, the inner tube portion 64 is surrounded by the outer tube portion 65 from the inner side in the radial direction. An outer diameter of the inner tube portion 64 is smaller than an inner diameter of the outer tube portion 65 of the housing body 6B. A gap functioning as a third flow path portion 93 is provided between the inner tube portion 64 and the outer tube portion 65.

The bearing holder 6E is arranged on the first side in the axial direction (+Y side) of the motor 2 inside the housing body 6B. The bearing holder 6E is fixed to an end surface on the first side in the axial direction (+Y side) of the water jacket 6D. The bearing holder 6E holds a bearing that rotatably supports the rotor 20. The bearing holder 6E of the present preferred embodiment is a plate-like member made from a metal material. The bearing holder 6E is formed by press working, for example. However, the configuration and manufacturing method of the bearing holder 6E are not limited to those in the present preferred embodiment.

The housing 6 includes a motor accommodation portion 81, a gear accommodation portion 82, and an inverter accommodation portion 83. The gear accommodation portion 82 is located on the second side in the axial direction (−Y side) of the motor accommodation portion 81. The inverter accommodation portion 83 is arranged on the first side in the axial direction (+Y side) of the motor accommodation portion 81. The motor accommodation portion 81, the gear accommodation portion 82, and the inverter accommodation portion 83 are configured by the inverter holder 6A, the housing body 6B, the gear cover 6C, and the water jacket 6D.

The motor accommodation portion 81 includes the motor peripheral wall portion 65e of the housing body 6B and the inner tube portion 64 of the water jacket 6D. The motor accommodation portion 81 is provided with a motor chamber breather 63. The motor chamber breather 63 allows the inside and the outside of the motor accommodation portion 81 to communicate with each other. The motor chamber breather 63 prevents excessive increase in pressure in an internal space of the motor accommodation portion 81.

The inverter accommodation portion 83 is configured by the inverter peripheral wall portion 65f of the housing body 6B and the inverter holder 6A. The inverter 7 is supported by the inverter holder 6A. A part of the inverter 7 is arranged on the inner side in the radial direction of the inverter peripheral wall portion 65f.

The gear accommodation portion 82 accommodates the power transmission unit 4 and a parking mechanism 50 to be described later. That is, the housing 6 accommodates the second shaft 44, the first gear 41, the second gear portion 48, the differential gear 4b, and the parking mechanism 50 in the gear accommodation portion 82. The gear accommodation portion 82 includes the partition wall portion 66 and the first gear peripheral wall portion 66a of the housing body 6B, and the opposing wall portion 67 and the second gear peripheral wall portion 67a of the gear cover 6C. Note that “the inside of the gear accommodation portion 82” (or “in the gear accommodation portion 82”) in description below means a space that is sandwiched between the partition wall portion 66 and the opposing wall portion 67 in the axial direction and is surrounded by the first gear peripheral wall portion 66a and the second gear peripheral wall portion 67a in the radial direction.

Fluid O is stored inside the gear accommodation portion 82. The fluid O is, for example, oil. In the present preferred embodiment, the fluid O is used as a refrigerant for cooling the motor 2. Further, the fluid O is used as lubricating oil for the power transmission unit 4 and a bearing. As the fluid O, for example, it is preferable to use oil equivalent to automatic transmission fluid (ATF) having relatively low viscosity in order to exhibit a function of a refrigerant and lubricating oil.

As shown in FIG. 1, the opposing wall portion 67 of the gear accommodation portion 82 is provided with a first protruding portion (protruding portion) 10 protruding to the second side in the axial direction (−Y side). That is, the housing 6 has the first protruding portion 10 protruding in the axial direction. Further, the first protruding portion 10 protrudes toward the outside of the housing 6. The first protruding portion 10 protrudes to the second side in the axial direction (−Y side) as compared with another portion of the opposing wall portion 67. That is, the first protruding portion 10 protrudes to the second side in the axial direction (−Y side) further than a portion that accommodates the first gear 41, the second gear portion 48, and the differential gear 4b of the gear accommodation portion 82.

The first protruding portion 10 is a part of the opposing wall portion 67 and swells outward so as to widen an internal space of the gear accommodation portion 82. A first accommodation space (accommodation space) 10a is provided inside the first protruding portion 10. The first accommodation space 10a is an internal space of a portion where the opposing wall portion 67 is recessed to the second side in the axial direction (−Y side) when viewed from the first side in the axial direction (+Y side), and expands an internal space of the gear accommodation portion 82 to the second side in the axial direction (−Y side). Further, an actuator 59 that transmits power to the parking mechanism 50 is fixed to an upper surface of the first protruding portion 10.

A plurality of attachment portions 67b and a plurality of linear ribs 67d are provided on a surface facing the second side in the axial direction (−Y side) of the opposing wall portion 67. In the present preferred embodiment, the attachment portion 67b has a boss shape and is provided with a bolt hole 67c. A bolt for fixing the housing 6 to a vehicle is fastened to the attachment portion 67b. A plurality of the linear ribs 67d connect a plurality of the attachment portions 67b. Two of a plurality of the linear ribs 67d cross each other.

In the present preferred embodiment, a protruding height of the attachment portion 67b and the linear rib 67d is larger than a protruding height of the first protruding portion 10. That is, end portions on the second side in the axial direction (−Y side) of the attachment portion 67b and the linear rib 67d are located further on the second side in the axial direction (−Y side) than an end portion on the second side in the axial direction (−Y side) of the first protruding portion 10. By the above, the attachment portion 67b and the linear rib 67d protect the first protruding portion 10 from a strong impact or the like in the event of an accident.

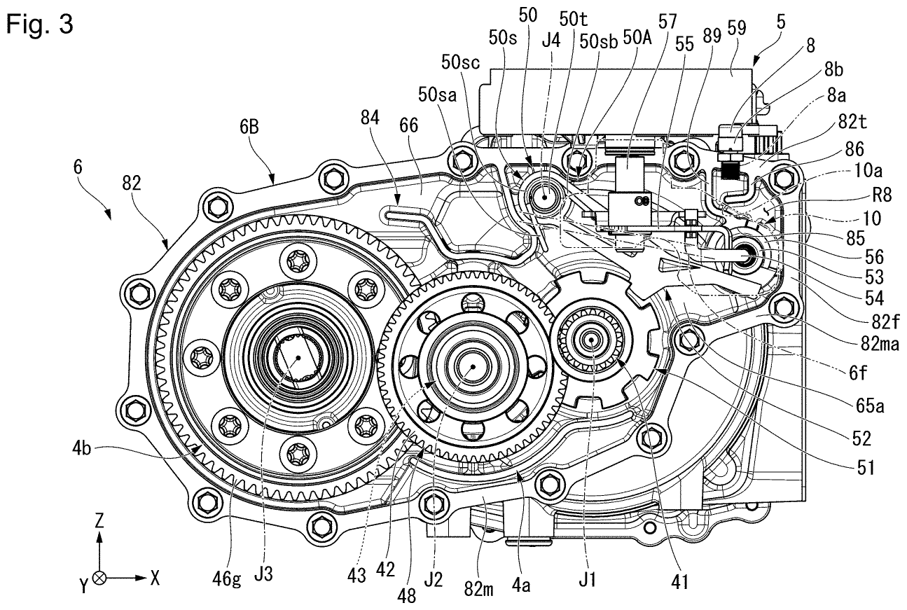

FIG. 3 is a front view of the gear accommodation portion 82 in a state where the gear cover 6C is removed.

The gear accommodation portion 82 includes a top surface portion 82t that covers an internal space of the gear accommodation portion 82 from the upper side, a bottom portion 82m that covers the internal space from the lower side, a front surface portion 82f that covers the internal space from the vehicle front side (+X side), and a portion that covers the internal space from the vehicle rear side.

A catch tank 84 is provided inside the gear accommodation portion 82. The catch tank 84 opens upward. The catch tank 84 of the present preferred embodiment has a rib shape or the like protruding from the partition wall portion 66 along the axial direction. A part of the catch tank 84 is connected to the top surface portion 82t.

The catch tank 84 receives the fluid O moved up by each gear (for example, the third gear 46g and the large-diameter gear 42) of the power transmission unit 4 inside the gear accommodation portion 82. The catch tank 84 supplies the fluid O to a bearing or the like through a hole portion (not shown).

The gear accommodation portion 82 is provided with a breather 8. The breather 8 is provided on the top surface portion 82t of the gear accommodation portion 82. That is, the breather 8 is located in an upper portion of the gear accommodation portion 82. The breather 8 allows the inside and the outside of the gear accommodation portion 82 to communicate each other to adjust internal pressure of the gear accommodation portion 82.

The breather 8 has a hole portion 8a and a pipe portion 8b attached to the hole portion 8a. The hole portion 8a is provided in the top surface portion 82t. The hole portion 8a of the present preferred embodiment is a circular hole linearly extending along the vertical direction. Further, a female screw is provided on an inner peripheral surface of the hole portion 8a. An outer peripheral surface of the pipe portion 8b is provided with a male screw that can be inserted into the female screw of the hole portion 8a. The pipe portion 8b is inserted into and fixed to the hole portion 8a. The pipe portion 8b has a tubular or substantially tubular shape with both ends opened, and connects the inside and the outside of the gear accommodation portion 82. A filter may be provided inside the pipe portion 8b. Further, a hose may be connected to a distal end of the pipe portion 8b.

The gear accommodation portion 82 is provided with a first dividing wall portion (dividing wall portion) 89 and a second dividing wall portion 86. The first dividing wall portion 89 and the second dividing wall portion 86 are arranged inside the gear accommodation portion 82. The first dividing wall portion 89 and the second dividing wall portion 86 extend along the axial direction. The first dividing wall portion 89 partitions a space (hereinafter, referred to as a breather chamber R8) in which the breather 8 opens inside the gear accommodation portion 82. The second dividing wall portion 86 is arranged inside the breather chamber R8. The second dividing wall portion 86 provides a complicated path inside the breather chamber R8.

According to the present preferred embodiment, by providing the breather chamber R8 surrounded by the first dividing wall portion 89 in the gear accommodation portion 82, it is possible to prevents the fluid O scattered in the gear accommodation portion 82 from reaching an opening of the breather 8. By the above, it is possible to prevents the fluid O from flowing out of the housing 6.

According to the present preferred embodiment, the second dividing wall portion 86 is provided in the breather chamber R8. The second dividing wall portion 86 further surrounds an opening of the breather 8 inside the breather chamber R8. As the second dividing wall portion 86 is provided, a labyrinth structure can be configured inside the breather chamber R8. The second dividing wall portion 86 can prevent the scattered fluid O from reaching the breather 8 even if the fluid O enters the breather chamber R8.

Note that a function of the second dividing wall portion 86 can also be described as further partitioning the inside of the breather chamber R8. That is, the second dividing wall portion 86 partitions a space where the breather 8 is opened inside the gear accommodation portion 82.

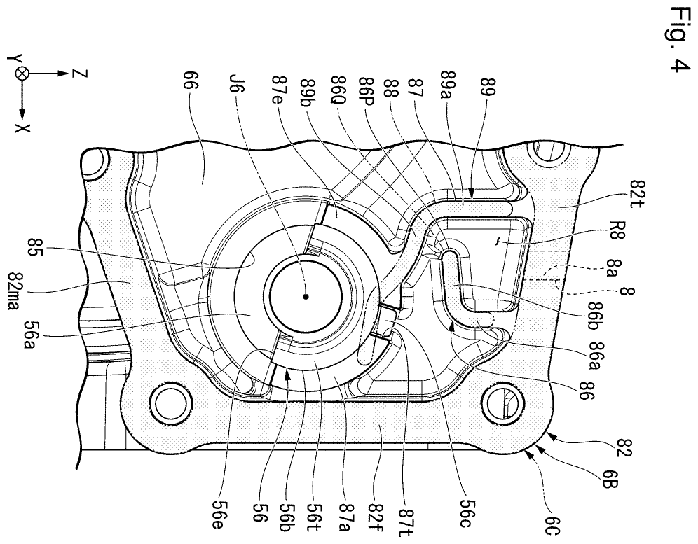

FIG. 4 is a front view of the gear accommodation portion 82 in the vicinity of the breather chamber R8.

The breather chamber R8 is arranged at an end portion on the vehicle front side (+X side) inside the gear accommodation portion 82. Further, the breather chamber R8 is arranged at an upper end portion inside the gear accommodation portion 82. The breather chamber R8 is surrounded by the front surface portion 82f and the top surface portion 82t of the gear accommodation portion 82 and the first dividing wall portion 89.

The first dividing wall portion 89 includes a first vertical dividing wall 89a extending downward from the top surface portion 82t of the gear accommodation portion 82, and a first lateral dividing wall 89b extending from a lower end of the first vertical dividing wall 89a toward the vehicle front side (+X side). The first lateral dividing wall 89b is inclined downward toward the vehicle front side (+X side). A distal end portion on the vehicle front side of the first lateral dividing wall 89b faces the front surface portion 82f of the gear accommodation portion 82 with a gap interposed between them. This gap allows the breather chamber R8 and another space in the gear accommodation portion 82 to communicate with each other. The first lateral dividing wall 89b is located immediately below an opening of the hole portion 8a of the breather 8.

The second dividing wall portion 86 has a second vertical dividing wall 86a extending downward from the top surface portion 82t of the gear accommodation portion 82, and a second lateral dividing wall 86b extending from a lower end of the second vertical dividing wall 86a toward the vehicle rear side (−X side). The second lateral dividing wall 86b is slightly inclined downward toward the vehicle rear side (−X side). A distal end portion on the vehicle rear side of the second lateral dividing wall 86b faces the first vertical dividing wall 89a with a gap interposed between them. The second lateral dividing wall 86b is arranged between an opening of the hole portion 8a of the breather 8 and the first lateral dividing wall 89b in the vertical direction.

The first dividing wall portion 89 and the second dividing wall portion 86 are configured by a pair of rib-shaped wall portions protruding and butting in directions facing each other from the housing body 6B and the gear cover 6C, respectively. Here, among wall portions constituting the first dividing wall portion 89, a wall portion protruding from the housing body 6B side to the second side in the axial direction (−Y side) is referred to as a first wall portion 87, and a wall portion protruding from the gear cover 6C side to the first side in the axial direction (+Y side) is referred to as a second wall portion 88. That is, the first dividing wall portion 89 has the first wall portion 87 which is a part of the housing body 6B and the second wall portion 88 which is a part of the gear cover 6C. Similarly, among wall portions constituting the second dividing wall portion 86, a wall portion protruding from the housing body 6B side to the second side in the axial direction (−Y side) is referred to as a third wall portion 86P, and a wall portion protruding from the gear cover 6C side to the first side in the axial direction (+Y side) is referred to as a fourth wall portion 86Q. That is, the second dividing wall portion 86 has the third wall portion 86P which is a part of the housing body 6B and the fourth wall portion 86Q which is a part of the gear cover 6C. Mating surfaces of the first wall portion 87 and the second wall portion 88 and mating surfaces of the third wall portion 86P and the fourth wall portion 86Q are arranged on the same plane as fastening surfaces of the housing body 6B and the gear cover 6C, respectively.

A part of the first wall portion 87 surrounds an outer periphery of a sleeve 56 of the parking mechanism 50 described later. Here, a portion that is a part of the first wall portion 87 and surrounds the outer periphery of the sleeve 56 is referred to as a sleeve guide portion 87a. The sleeve guide portion 87a is provided with a notch portion 87t.

An extension wall portion 87e is connected to the first wall portion 87. That is, the extension wall portion 87e is provided in the partition wall portion 66 of the housing body 6B. The extension wall portion 87e extends from the sleeve guide portion 87a to the vehicle rear side (−X side). The extension wall portion 87e extends in an arc shape or substantially arc shape along an outer peripheral surface of the sleeve 56.

An upper end portion of the first wall portion 87 is connected to the top surface portion 82t of the gear accommodation portion 82. On the other hand, an upper end portion of the second wall portion 88 is not connected to the top surface portion 82t. The upper end portion of the second wall portion 88 faces the top surface portion 82t in the vertical direction with a gap interposed between them. Therefore, a gap is partially provided between the first dividing wall portion 89 and the top surface portion 82t. By the above, a communication path to the breather chamber R8 is more reliably secured.

An upper end portion of the third wall portion 86P is connected to the top surface portion 82t of the gear accommodation portion 82. On the other hand, an upper end portion of the fourth wall portion 86Q is not connected to the top surface portion 82t. The upper end portion of the fourth wall portion 86Q faces the top surface portion 82t in the vertical direction with a gap interposed between them. A gap is partially provided between the second dividing wall portion 86 and the top surface portion 82t. By the above, it is possible to reliably prevent a periphery of an opening of the breather 8 from being completely closed.

As shown in FIG. 2, the housing 6 is provided with a flow path 90 through which cooling water L flows. The cooling water L is, for example, water. The flow path 90 includes external piping 97 that passes through the outside of the housing 6, and a first flow path portion 91, a second flow path portion 92, a third flow path portion 93, and a fourth flow path portion 94 that pass through the inside of the housing 6.

The external piping 97 is piping connected to the housing 6. A radiator (not shown) for cooling the cooling water L is arranged in a path of the external piping 97. The cooling water L flows through the first flow path portion 91, the second flow path portion 92, the third flow path portion 93, and the fourth flow path portion 94 in this order inside the housing 6. The first flow path portion 91 is provided in the inverter accommodation portion 83. The first flow path portion 91 is connected to the external piping 97. The cooling water L flowing through the first flow path portion 91 cools the inverter 7. The second flow path portion 92 is provided in the outer tube portion 65 of the housing body 6B. The second flow path portion 92 connects the first flow path portion 91 and the third flow path portion 93. The third flow path portion 93 is arranged between the outer tube portion 65 of the housing body 6B and the inner tube portion 64 of the water jacket 6D. A spiral projecting portion is provided on an outer peripheral surface of the inner tube portion 64. By the above, the third flow path portion 93 extends spirally along the circumferential direction. The cooling water L flowing through the third flow path portion 93 cools the stator 30. The fourth flow path portion 94 is provided in the outer tube portion 65 of the housing body 6B. The fourth flow path portion 94 connects third flow path portion 93 and external piping 97.

The parking device 5 is arranged inside the gear accommodation portion 82. The parking device 5 locks rotation of one shaft (the second shaft 44 in the present preferred embodiment) of the power transmission unit 4.

The parking device 5 includes an actuator 59 and the parking mechanism 50 driven by the actuator 59. That is, the drive apparatus 1 includes the parking mechanism 50 and the actuator 59. The actuator 59 is arranged outside the housing 6. On the other hand, the parking mechanism 50 is arranged inside the housing 6 (more specifically, the gear accommodation portion 82).

The actuator 59 operates the parking mechanism 50. The actuator 59 switches the parking mechanism 50 between a locked state in which rotation of the second shaft 44 is blocked and an unlocked state in which rotation of the second shaft 44 is allowed. The parking device 5 is in the locked state in a case where a gear of the vehicle is in parking, and is in the unlocked state in a case where the gear of the vehicle is in a position other than parking. The case where the gear of the vehicle is in a position other than parking includes, for example, a case where the gear of the vehicle is in drive, neutral, reverse, or the like.

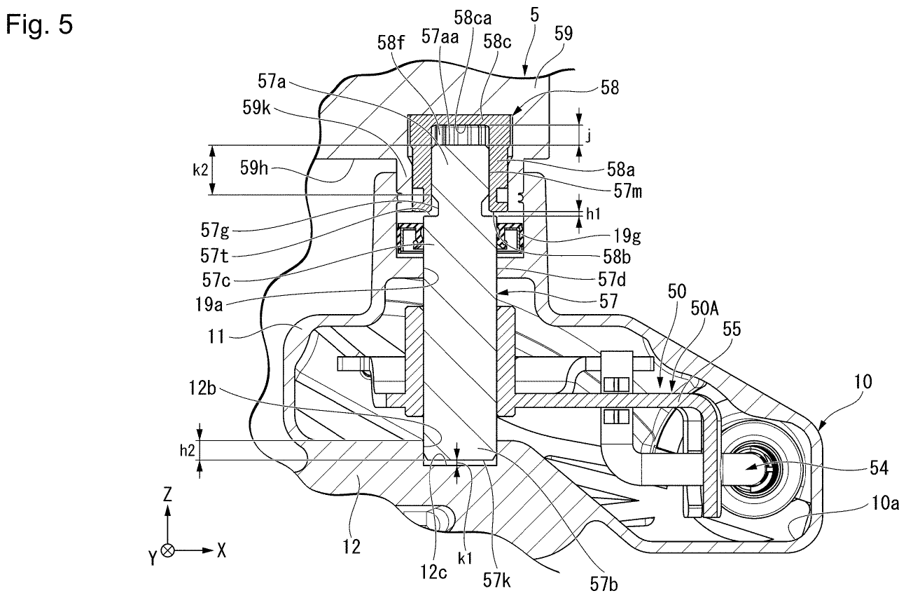

FIG. 5 is a cross-sectional view of the drive apparatus 1 at a connection portion between the actuator 59 and the parking mechanism 50 of the present preferred embodiment.

The actuator 59 includes a rotation unit 58 and a housing 59h. Further, although not shown, the actuator 59 includes a driving motor, a transmission mechanism, and the like arranged inside the housing 59h.

The rotation unit 58 rotates about a drive axis J5 by power of the driving motor. The rotation unit 58 includes a cylindrical tube portion 58a, a bottom portion 58c, and a first surface 58b.

In description below, the actuator 59 and a rotary shaft 57 connected to the actuator 59 will be described with reference to the drive axis J5. In the present preferred embodiment, the first side in the axial direction of the drive axis J5 means the lower side (−Z side), and the second side in the axial direction of the drive axis J5 means the upper side (+Z side).

The tube portion 58a has a cylindrical or substantially cylindrical shape around the drive axis J5 extending along the vertical direction. The tube portion 58a opens to the first side in the axial direction (lower side) of the drive axis J5. Further, the bottom portion 58c is provided on the second side in the axial direction (upper side) of the drive axis J5 of the tube portion 58a. A plurality of spline grooves 58f extending in the axial direction of the drive axis J5 are provided on an inner peripheral surface of the tube portion 58a. That is, the spline groove 58f is provided in the tube portion 58a. The rotary shaft 57 of the parking mechanism 50 is inserted into and connected to the tube portion 58a from below. The actuator 59 transmits power to the parking mechanism 50 at the tube portion 58a.

The first surface 58b faces the first side in the axial direction (lower side) of the drive axis J5. The first surface 58b is a lower end surface of the tube portion 58a. The first surface 58b is located at an opening edge of the tube portion 58a. The first surface 58b is an annular surface surrounding the drive axis J5.

The housing 59h has a support tube 59k surrounding the tube portion 58a. The support tube 59k has a cylindrical or substantially cylindrical shape around the drive axis J5. The support tube 59k rotatably supports the tube portion 58a. An O-ring is arranged between an inner peripheral surface of the support tube 59k and an outer peripheral surface of the tube portion 58a to prevent liquid from entering the housing 59h.

The actuator 59 is attached to the upper side of the first protruding portion 10 of the housing 6. The first protruding portion 10 has an upper wall (first wall) 11 and a lower wall (second wall) 12 facing each other in the vertical direction. The upper wall 11 and the lower wall 12 extend along the horizontal direction.

The upper wall 11 is provided with a through hole 19a around the drive axis J5. The through hole 19a penetrates the upper wall 11 in the vertical direction. Further, the upper wall 11 is provided with a connecting tube portion 19 extending upward from an upper surface of the upper wall 11. The connecting tube portion 19 surrounds the through hole 19a from the outer side in the radial direction of the drive axis J5. A diameter of an inner peripheral surface of the connecting tube portion 19 is larger than a diameter of the through hole 19a. The support tube 59k of the actuator 59 is inserted into the connecting tube portion 19 from the outside of the housing 6. An O-ring is arranged between an inner peripheral surface of the connecting tube portion 19 and an outer peripheral surface of the support tube 59k to prevent liquid from entering the housing 6.

The connecting tube portion 19 surrounds the rotary shaft 57 of the parking mechanism 50 from the outer side in the radial direction of the drive axis J5. A gasket 19g is fixed to an inner peripheral surface of the connecting tube portion 19. An inner peripheral surface of the gasket 19g is in contact with an outer peripheral surface of the rotary shaft 57 inserted into the connecting tube portion 19. The gasket 19g seals a gap between an inner peripheral surface of the connecting tube portion 19 and an outer peripheral surface of the rotary shaft 57.

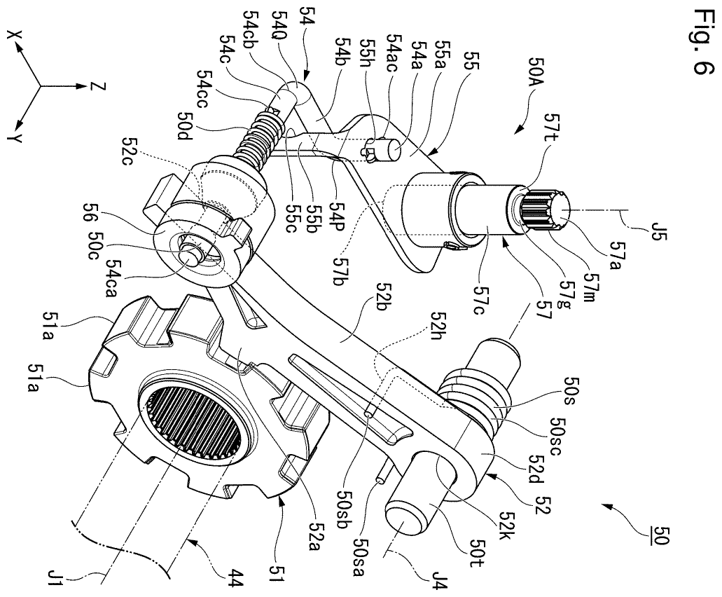

FIG. 6 is a perspective view of the parking mechanism 50.

The parking mechanism 50 includes a parking gear 51, a parking pawl 52, a transmission unit 50A that transmits power to the parking pawl 52, and a tubular sleeve 56. Further, the transmission unit 50A includes a pawl shaft 50t, a cam rod 54, a cam 53, a coil spring 50d, a flange 55, and a rotary shaft 57. The transmission unit 50A receives power from the actuator 59 at the rotary shaft 57, and transmits power to the parking pawl 52 at the cam 53.

As shown in FIG. 5, the rotary shaft 57, the flange 55, and a part of the cam rod 54 are accommodated in the first accommodation space 10a inside the first protruding portion 10. That is, at least a part of the transmission unit 50A is accommodated in the first accommodation space 10a.

As shown in FIG. 2, the gear accommodation portion 82 has the first protruding portion 10. Further, the first accommodation space 10a inside the first protruding portion 10 accommodates at least a part of the transmission unit 50A of the parking mechanism 50. According to the present preferred embodiment, by locally enlarging a part of the gear accommodation portion 82 in accordance with a shape of the parking mechanism 50 instead of enlarging the gear accommodation portion 82 in one direction in order to secure accommodation volume of the parking mechanism 50, an outer shape of the gear accommodation portion 82 can be downsized as a whole. Further, since the first protruding portion 10 of the present preferred embodiment protrudes in the axial direction (Y-axis direction), it is possible to prevent increase in a projection area in the axial direction of the drive apparatus 1. For this reason, an accommodation space of the drive apparatus 1 in a vehicle is less likely to become large.

As shown in FIG. 2, the first protruding portion 10 of the present preferred embodiment overlaps at least a part of the large-diameter gear 42 when viewed from a direction perpendicular to the axial direction. In other words, a position in the axial direction of the first protruding portion 10 overlaps a position in the axial direction of the large-diameter gear 42. According to the present preferred embodiment, by arranging the first protruding portion 10 to overlap the gear of the power transmission unit 4 in the axial direction, it is possible to prevent increase in size of the gear accommodation portion 82 in the axial direction with respect to a protruding amount of the first protruding portion 10.

As shown in FIG. 5, the rotary shaft 57 has a columnar or substantially columnar shape around the drive axis J5. The rotary shaft 57 has a first end portion 57a located on the second side in the axial direction (upper side) of the drive axis J5 and a second end portion 57b located on the first side in the axial direction (lower side). The rotary shaft 57 is connected to the actuator 59. The rotary shaft 57 rotates around the drive axis J5 by power of the actuator 59.

The rotary shaft 57 extends into and out of the housing 6. The first end portion 57a is arranged outside the housing 6. On the other hand, the second end portion 57b is arranged inside the housing 6. That is, at least a part of the rotary shaft 57 is arranged inside the housing 6. The rotary shaft 57 is connected to the actuator 59 outside the housing 6 and to the flange 55 inside the housing 6.

A plurality of spline projections 57m extending in the axial direction of the drive axis J5 are provided on an outer peripheral surface of the first end portion 57a. The first end portion 57a is inserted into the tube portion 58a of the actuator 59. By the above, the spline projection 57m of the first end portion 57a is fitted into the spline groove 58f of the tube portion 58a, and the rotary shaft 57 is connected to the tube portion 58a. Since connection between the rotary shaft 57 and the tube portion 58a is spline fitting, relative movement of the drive axis J5 in the axial direction is allowed.

The first end portion 57a has a small outer diameter as compared with another portion of the rotary shaft 57. Here, a portion excluding the first end portion 57a of the rotary shaft 57 is referred to as a large-diameter portion 57c. That is, the rotary shaft 57 has a large-diameter portion 57c having a diameter larger than that of the first end portion 57a. The second end portion 57b is a part of the large-diameter portion 57c.

A stepped second surface 57t is provided between the first end portion 57a and the large-diameter portion 57c. The second surface 57t is an upper end surface of the large-diameter portion 57c. The second surface 57t is an annular surface surrounding the drive axis J5. The second surface 57t faces the second side in the axial direction (upper side) of the drive axis J5. The second surface 57t faces the first surface 58b of the actuator 59 in the axial direction of the drive axis J5.

A recess portion 57g having an outer diameter smaller than that of the first end portion 57a is provided between the first end portion 57a and the large-diameter portion 57c. The recess portion 57g extends in a groove or substantially groove shape along the circumferential direction. In general, it is difficult to form a complete shape of the spline projection 57m up to a root in the axial direction. According to the present preferred embodiment, by providing the recess portion 57g, it is possible to remove an incomplete spline shape at a root of the spline projection 57m.

The large-diameter portion 57c is provided with a supported portion 57d rotatably supported by the upper wall 11 of the housing 6. That is, the rotary shaft 57 includes the supported portion 57d. The supported portion 57d is in contact with an inner peripheral surface of the through hole 19a on an outer peripheral surface. The through hole 19a has a circular or substantially circular shape in plan view around the drive axis J5. An inner diameter of the through hole 19a is slightly larger than an outer diameter of the supported portion 57d. The supported portion 57d is inserted into the through hole 19a and rotatably supported. That is, the through hole 19a functions as a sliding bearing for the rotary shaft 57.

The second end portion 57b is located on the opposite side of the first end portion 57a. The second end portion 57b is rotatably supported by the lower wall 12 of the housing 6. On an upper surface of the lower wall 12, a recess 12b around the drive axis J5 is provided. That is, the housing 6 has the recess 12b. The recess 12b has a circular or substantially circular shape in plan view around the drive axis J5. The second end portion 57b is inserted into the recess 12b.

The second end portion 57b has a fourth surface 57k facing the first side in the axial direction (lower side). The fourth surface 57k is a lower end surface of the rotary shaft 57. The fourth surface 57k faces a bottom surface 12c of the recess 12b. The fourth surface 57k and the bottom surface 12c may be in contact with each other. An inner diameter of the recess 12b is slightly larger than an outer diameter of the second end portion 57b. The second end portion 57b is rotatably supported by the recess 12b. That is, the recess 12b functions as a sliding bearing with respect to the rotary shaft 57.

The rotary shaft 57 of the present preferred embodiment is rotatably supported by the upper wall 11 and the lower wall 12 facing each other in the axial direction of the drive axis J5. According to the present preferred embodiment, it is possible to stabilize the support of the rotary shaft 57 as compared with a case where the rotary shaft 57 is cantilevered.

In the present preferred embodiment, the rotary shaft 57 is connected to the rotation unit 58 of the actuator 59 by spline fitting. By employing spline fitting for a connection mechanism between the rotary shaft 57 and the rotation unit 58, assemblability of the parking mechanism 50 and the actuator 59 can be enhanced, but on the other hand, movement of the rotary shaft 57 in the axial direction with respect to the rotation unit 58 is allowed. For this reason, there is a possibility that the rotary shaft 57 is separated from a bearing portion (the recess 12b of the present preferred embodiment). For this reason, in a conventional structure, separation of the rotary shaft 57 has been prevented by use of a separate member such as an E-shaped retaining ring or a pin.

According to the present preferred embodiment, the first surface 58b of the actuator 59 and the second surface 57t of the rotary shaft 57 face each other in the axial direction of the drive axis J5. The first surface 58b comes into contact with the second surface 57t to restrict upward movement of the rotary shaft 57. According to the present preferred embodiment, it is possible to provide the drive apparatus 1 in which movement of the rotary shaft 57 to the upper side can be restricted without use of a separate member such as an E retaining ring and a pin, the number of parts is reduced, and assembly is easy.

According to the present preferred embodiment, the first surface 58b is provided on the rotation unit 58 of the actuator 59. For this reason, even in a case where the first surface 58b and the second surface 57t come into contact with each other, dynamic frictional force resistance does not occur between the first surface 58b and the second surface 57t. According to the present preferred embodiment, separation of the rotary shaft 57 can be prevented without reduction of power transmission efficiency from the actuator 59 to the rotary shaft 57.

In the present preferred embodiment, a distance dimension h1 between the first surface 58b and the second surface 57t in the axial direction of the drive axis J5 is smaller than an insertion depth h2 into the recess 12b of the second end portion 57b. For this reason, even when the rotary shaft 57 moves upward (the second side in the axial direction of the drive axis J5) which is a direction to be separated from the recess 12b, the first surface 58b and the second surface 57t come into contact with each other. The first surface 58b and the second surface 57t restrict upward movement of the rotary shaft 57, and prevents the rotary shaft 57 from being separated from the recess 12b.

The distance dimension h1 and the insertion depth h2 change as the rotary shaft 57 moves in the axial direction of the drive axis J5 with respect to the housing 6. The distance dimension h1 and the insertion depth h2 have a correlation with each other. When the distance dimension h1 decreases due to upward movement of the rotary shaft 57, the insertion depth h2 also decreases by the same amount. For this reason, as long as the rotary shaft 57 satisfies the above-described relationship at an optional position, the above-described relationship is satisfied at any position.

Further, according to the present preferred embodiment, a distance dimension j between an end surface 57aa (that is, an upper end surface) of the first end portion 57a and a bottom surface 58ca of the rotation unit 58 is sufficiently larger than the distance dimension h1 between the first surface 58b and the second surface 57t. For this reason, it is possible to prevent the end surface 57aa and the bottom surface 58ca from first coming into contact with each other before the first surface 58b and the second surface 57t come into contact with each other. As a result, the first surface 58b and the second surface 57t can reliably function as surfaces that restrict movement of the rotary shaft 57.

In the present preferred embodiment, the first surface 58b is provided on an end surface of the tube portion 58a facing the first side in the axial direction (lower side) of the drive axis J5. Since an end surface of the tube portion 58a is relatively easily processed, surface accuracy is easily improved. According to the present preferred embodiment, the rotation unit 58 having the first surface 58b with high accuracy can be formed, and the distance dimension h1 with respect to the second surface 57t can be easily managed.

Further, by providing the first surface 58b on an end surface of the tube portion 58a, the first surface 58b can be formed into an annular or substantially annular shape around the drive axis J5. By the above, the first surface 58b and the second surface 57t can be stably brought into contact with each other around the drive axis J5.

In the present preferred embodiment, the second surface 57t is a surface connecting the large-diameter portion 57c and the first end portion 57a in a step shape. According to the present preferred embodiment, the second surface 57t can be formed in an annular shape around the drive axis J5, and the first surface 58b and the second surface 57t can be stably brought into contact with each other around the drive axis J5. Note that, in the present preferred embodiment, the recess portion 57g is provided at a root of the spline projection 57m, and an incomplete spline shape at the root of the spline projection 57m is removed. For this reason, the spline projection 57m can be inserted into the spline groove 58f until the first surface 58b and the second surface 57t come into contact with each other.

Note that the positions of the first surface 58b and the second surface 57t described in the present preferred embodiment are an example. The locations of the first surface 58b and the second surface 57t are not limited as long as they are provided on the rotation unit 58 and the rotary shaft 57, respectively. For example, the first surface may be provided on the bottom portion 58c of the rotation unit 58, and the second surface may be provided on an end surface of the first end portion 57a of the rotary shaft 57.

In the present preferred embodiment, the second end portion 57b of the rotary shaft 57 faces the bottom surface 12c of the recess 12b on the fourth surface 57k. The bottom surface 12c comes into contact with the fourth surface 57k to restrict movement to the lower side of the rotary shaft 57 so as to prevent separation of the spline projection 57m from the spline groove 58f.

In the present preferred embodiment, a distance dimension k1 between the fourth surface 57k and the bottom surface 12c in the axial direction of the drive axis J5 is smaller than a fitting length k2 of the spline projection 57m and the spline groove 58f. For this reason, even when the spline projection 57m moves to the lower side (first side in the axial direction of the drive axis J5) in a direction of separating from the spline groove 58f, the fourth surface 57k and the bottom surface 12c come into contact with each other. The fourth surface 57k and the bottom surface 12c restrict movement to the lower side of the rotary shaft 57 and prevents separation of the spline projection 57m from the spline groove 58f.

Note that the distance dimension k1 and the fitting length k2 have the same correlation as the relationship between the distance dimension h1 and the insertion depth h2 described above. For this reason, the distance dimension k1 and the fitting length k2 satisfy the above-described relationship at any position as long as the rotary shaft 57 satisfies the above-described relationship at an optional position.

The rotary shaft 57 of the present preferred embodiment is assembled from the outside of the housing 6. Here, a process of assembling the rotary shaft 57 and the actuator 59 to the housing 6, which is an assembling method of the drive apparatus 1, will be specifically described. This assembling method includes a shaft insertion process of inserting the rotary shaft 57 into the housing 6, and a connection process of allowing the actuator 59 to communicate with the first end portion 57a of the rotary shaft 57.

In the shaft insertion process, an operator first inserts the rotary shaft 57 into the housing 6 from the through hole 19a provided in the upper wall 11. At this time, the operator inserts the rotary shaft 57 into the through hole 19a from the second end portion 57b side. Further, the operator inserts the second end portion 57b of the rotary shaft 57 into the recess 12b of the lower wall 12. By the above, the operator allows the rotary shaft 57 to be supported across the upper wall 11 and the lower wall 12. The rotary shaft 57 after the shaft insertion process protrudes from the housing 6 at the first end portion 57a.

In the connection process, the operator connects the actuator 59 to the first end portion 57a protruding from the housing 6. In the connection process, the operator causes the first surface 58b of the actuator 59 and the second surface 57t of the rotary shaft 57 to face each other in the axial direction of the drive axis J5. After the connection process, the actuator 59 is fastened and fixed to an outer surface of the housing 6 with a bolt or the like.

According to the assembling method of the present preferred embodiment, the rotary shaft 57 can be prevented from falling off in the housing 6 only by inserting the rotary shaft 57 into the through hole 19a and connecting the actuator 59. That is, a process of attaching a retainer to the rotary shaft 57 is not required, and an assembly process can be simplified. Note that, in the assembling method of the present preferred embodiment, in the shaft insertion process, the flange 55 is preferably fixed to an outer peripheral surface of the rotary shaft 57 in the first accommodation space 10a before the rotary shaft 57 is inserted into the recess 12b.

The flange 55 is provided on an outer peripheral surface of the rotary shaft 57. The flange 55 of the present preferred embodiment is a separate member from the rotary shaft 57 and is fixed to an outer peripheral surface of the rotary shaft 57. However, the flange 55 may be part of the rotary shaft 57.

The flange 55 is arranged between the upper wall 11 and the lower wall 12 of the first protruding portion 10. As described above, the rotary shaft 57 is rotatably supported with respect to the upper wall 11 and the lower wall 12. As the flange 55 is fixed to the rotary shaft 57 between the upper wall 11 and the lower wall 12, the upper wall 11 and the lower wall 12 can support the flange 55 and the rotary shaft 57 at both ends. For this reason, the upper wall 11 and the lower wall 12 can stably support the rotary shaft 57 against a reaction force applied from the flange 55 to the rotary shaft 57.

The flange 55 extends along the radial direction of the drive axis J5. The flange 55 rotates around the drive axis J5 together with the rotary shaft 57. According to the present preferred embodiment, the rotary shaft 57 extends along the vertical direction inside the first protruding portion 10. Further, the flange 55 rotates along a plane orthogonal to the vertical direction between the upper wall 11 and the lower wall 12 of the first protruding portion 10. According to the structure of the present preferred embodiment, each part of the transmission unit 50A can be efficiently arranged by effective use of the first accommodation space 10a inside the first protruding portion 10.

As shown in FIG. 6, the flange 55 of the present preferred embodiment includes a flange body 55a extending along the radial direction of the drive axis J5, and a protruding piece 55b provided at a distal end of the flange body 55a. The protruding piece 55b protrudes from the flange body 55a along the axial direction of the drive axis J5.

The flange body 55a has a plate shape orthogonal to the drive axis J5. The flange body 55a is provided with a connection hole 55h penetrating in the thickness direction. The connection portion 54a of the cam rod 54 passes through the connection hole 55h. The connection portion 54a of the cam rod 54 is rotatable about the connection hole 55h.

The cam rod 54 includes the connection portion 54a, a joint portion 54b, and a rod body 54c. In the cam rod 54, a first bent portion 54P is provided between the connecting portion 54a and the joint portion 54b, and a second bent portion 54Q is provided between the joint portion 54b and the rod body 54c. The cam rod 54 is bent at approximately 90° in each of the first bent portion 54P and the second bent portion 54Q. The cam rod 54 has a rod shape with a circular cross section bent at the first bent portion 54P and the second bent portion 54Q.

The connection portion 54a extends along the axial direction of the drive axis J5. Therefore, the connection portion 54a extends in parallel with the rotary shaft 57. The connection portion 54a is inserted into the connection hole 55h of the flange 55. By the above, the connection portion 54a is rotatably connected to and supported by the flange 55. That is, the cam rod 54 is rotatably supported by the flange 55 at the connection portion 54a. On an outer periphery of the connection portion 54a, a projection 54ac that suppresses detachment of the connection portion 54a from the connection hole 55h is provided.

The rod body 54c extends along the axial direction of the central axis J1. The rod body 54c extends in a direction orthogonal to the connection portion 54a. The rod body 54c passes through the inside of the sleeve 56. The rod body 54c is guided by the sleeve 56. Further, the cam rod 54 moves along the axial direction of the central axis J1 along with movement (that is, rotation around the drive axis J5) of the flange 55.

The joint portion 54b connects the connection portion 54a and the rod body 54c. The joint portion 54b is orthogonal to the connection portion 54a and the rod body 54c. The joint portion 54b extends along a direction orthogonal to the drive axis J5 and the central axis J1. One end of the joint portion 54b is connected to the connection portion 54a, and the other end is connected to the rod body 54c.

The joint portion 54b extends along the axial direction of the central axis J1. The joint portion 54b is provided to shift relative positions between the connection portion 54a and the rod body 54c. As the joint portion 54b is arranged to extend along the radial direction of the central axis J1, the connection portion 54a can be arranged close to the central axis J1 with respect to the rod body 54c. Therefore, while the cam 53 supported by the rod body 54c is arranged at an optimum position, the flange 55, the rotary shaft 57, the actuator 59, and the like connected to the connection portion 54a can be arranged close to the central axis J1 side. By the above, each part of the parking mechanism 50 can be densely arranged around the central axis J1, and an arrangement space of the parking mechanism 50 in the drive apparatus 1 can be reduced.

The protruding piece 55b of the flange 55 is arranged on the first side in the axial direction (+Y side) of the joint portion 54b. The protruding piece 55b is arranged on the parking gear 51 side with respect to the joint portion 54b in the axial direction of the central axis J1 so as to overlap the joint portion 54b when viewed from the axial direction of the central axis J1, and the protruding piece 55b has a facing surface 55c facing the joint portion 54b. The facing surface 55c faces the joint portion 54b with a gap interposed between them in the axial direction of the central axis J1.

The coil spring 50d, the cam 53, and a cap 50c pass through the rod body 54c. That is, the coil spring 50d, the cam 53, and the cap 50c are attached to the rod body 54c.

In description below, an end portion, of the rod body 54c, on the side connected to the joint portion 54b is referred to as a proximal end 54cb, and an end portion opposite to the proximal end 54cb is referred to as a distal end 54ca.

The coil spring 50d is arranged on the proximal end 54cb side of the rod body 54c with respect to the cam 53. A projection 54cc larger than an inner diameter of the coil spring 50d is provided on an outer periphery of the proximal end 54cb of the rod body 54c. The coil spring 50d is arranged between the projection 54cc and the cam 53 in a state of being compressed with respect to a natural length. The coil spring 50d applies a force toward the distal end 54ca side of the rod body 54c to the cam 53.

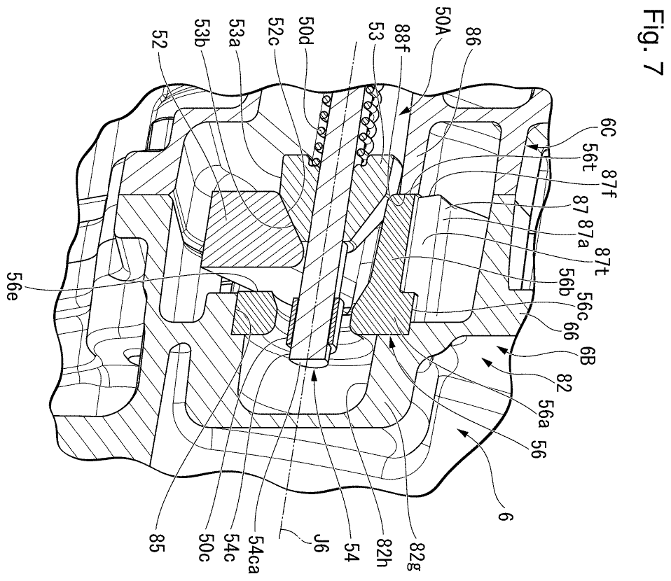

FIG. 7 is a cross-sectional view of the drive apparatus 1 in the vicinity of the distal end 54ca of the rod body 54c.

The cap 50c is fixed to the distal end 54ca of the rod body 54c. The cap 50c is arranged closer to the distal end 54ca than the cam 53 in the rod body 54c. The cap 50c is in contact with an end surface of the cam 53. The cap 50c restricts movement of the cam 53 to the distal end 54ca side with respect to the rod body 54c. The cap 50c prevents the cam 53 from falling off the distal end 54ca of the rod body 54c.

The cam 53 has an annular shape around the rod body 54c. The rod body 54c is inserted into a through hole at the center of the cam 53. An inner diameter of the through hole of the cam 53 is larger than an outer diameter of the rod body 54c. The cam 53 is sandwiched between the coil spring 50d and the cap 50c in a length direction of the rod body 54c. The coil spring 50d is compressed as the cam 53 moves toward the proximal end 54cb side. In a case of receiving a force toward the proximal end 54cb side stronger than a repulsive force of the coil spring 50d, the cam 53 compresses the coil spring 50d and moves toward the proximal end 54cb side with respect to the rod body 54c.

An outer peripheral surface of the cam 53 is in contact with a cam contact portion 52c of the parking pawl 52. The cam has a first portion 53a and a second portion 53b. The first portion 53a and the second portion 53b are coaxially arranged. The second portion 53b is located on the distal end 54ca side with respect to the first portion 53a. Each of the first portion 53a and the second portion 53b has a truncated cone or substantially truncated cone shape. Outer peripheral surfaces of the first portion 53a and the second portion 53b are conical tapered surfaces whose outer diameter gradually decreases from the proximal end 54cb side toward the distal end 54ca side of the rod body 54c. Therefore, each of the first portion 53a and the second portion 53b has a circular cross section. A taper angle of an outer peripheral surface of the first portion 53a is sufficiently smaller than a taper angle of an outer peripheral surface of the second portion 53b. A taper angle of an outer peripheral surface of the second portion 53b is set to a sufficient angle at which the cam 53 can be smoothly detached from between the sleeve 56 and the cam contact portion 52c at the time of transition from the locked state to the unlocked state. Note that the first portion 53a may have a columnar shape instead of a truncated cone shape.

Operation of the rod body 54c is transmitted to the cam 53 via the coil spring 50d. By the above, the cam 53 moves along the length direction of the rod body 54c together with the rod body 54c. Further, the cam 53 is in contact with the cam contact portion 52c of the parking pawl 52 on an outer peripheral surface. The cam 53 moves with operation of the cam rod 54 to operate the parking pawl 52. In the parking mechanism 50 in the unlocked state, the second portion 53b of the cam 53 faces the cam contact portion 52c of the parking pawl 52 via a gap. In the parking mechanism 50 in the locked state and a standby state, the cam 53 comes into contact with the cam contact portion 52c in the first portion 53a. When the state of the parking mechanism 50 is switched between the locked state and the unlocked state, the cam 53 comes into contact with the cam contact portion 52c in the second portion 53b and further slides. By the above, the cam 53 moves the cam contact portion 52c to the upper side and rotates the parking pawl 52 around a support axis J4. Further, the standby state is a state in which a protrusion 52a is pressed against an outer peripheral surface of a tooth portion 51a of the parking gear 51. In the standby state, even if the cam rod 54 moves to the position of the locked state, the cam 53 cannot move, and the cam 53 is in a state of being pressed against the cam contact portion 52c. By the above, the coil spring 50d is compressed between the cam 53 and the projection 54cc of the rod body 54c. The coil spring 50d presses the cam 53 against the cam contact portion 52c until the parking gear 51 rotates and the protrusion 52a meshes between the tooth portions 51a.

The sleeve 56 has a tubular shape extending along a sleeve axis J6. The distal end 54ca of the rod body 54c is inserted into the sleeve 56. Further, the sleeve 56 supports the cam 53 from the opposite side of the parking pawl 52 in the locked state. Note that the cam 53 is separated from the sleeve 56 in the unlocked state. The sleeve 56 guides the cam 53 to limit an operation range of the cam 53 and the cam rod 54. The sleeve 56 is provided with a sleeve notch portion 56e where a part of an inner side surface is opened to the outside in the radial direction. The sleeve 56 is fixed to an inner surface of the housing 6. The sleeve 56 fixing method will be described in detail later.

According to the present preferred embodiment, the flange 55 is provided with the protruding piece 55b. The protruding piece 55b is used in a process of assembling the parking mechanism 50 to the housing 6. After the transmission unit 50A is assembled to the housing 6, the parking mechanism 50 inserts the cam rod 54 into the sleeve 56 and causes the housing 6 to hold the sleeve 56. There is a case where the process of inserting the cam rod 54 into the sleeve 56 and attaching the sleeve 56 to the housing 6 (hereinafter, the sleeve attachment process) is performed in a state where the housing 6 is inclined. The sleeve attachment process of the present preferred embodiment is performed in a posture in which the housing 6 is inclined so that the side to which an arrow of the Y axis in the diagram is directed is the lower side in the vertical direction. In the sleeve attachment process, the protruding piece 55b of the flange 55 is arranged below the joint portion 54b of the cam rod 54. In the sleeve attachment process, the operator inserts the distal end 54ca of the rod body 54c into the sleeve 56 by causing the protruding piece 55b to support the joint portion 54b from below. Further, the operator fixes the sleeve 56 to an inner surface of the housing 6. According to the present preferred embodiment, the cam rod 54 that tends to be unstable in the assembly process can be temporarily held by the protruding piece 55b. By the above, work of inserting the distal end 54ca of the rod body 54c into the sleeve 56 can be easily performed, and the assembly process of the parking mechanism 50 can be simplified.

As shown in FIG. 2, the parking gear 51 is provided on an outer peripheral surface of the second shaft 44. The parking gear 51 is arranged between the first gear 41 and the partition wall portion 66 in the axial direction.

According to the present preferred embodiment, the parking gear 51 is arranged between the motor 2 and the first gear 41 in the axial direction. That is, the parking gear 51 is arranged on the partition wall portion 66 side with respect to the first gear 41. By the above, the parking mechanism 50 can be arranged close to the motor 2 side in the gear accommodation portion 82, and the parking mechanism 50 can be prevented from being arranged so as to protrude significantly from the gear accommodation portion 82 to the first side in the axial direction (+Y side). As a result, reduction in the dimension in the axial direction of the drive apparatus 1 can be achieved.

According to the present preferred embodiment, the parking gear 51 overlaps at least a part of the third gear 46g when viewed from a direction perpendicular to the axial direction. In other words, a position in the axial direction of the parking gear 51 overlaps a position in the axial direction of the third gear 46g. According to the present preferred embodiment, the parking mechanism 50 and the power transmission unit 4 can be arranged to overlap each other in the axial direction. That is, the parking mechanism 50 can be arranged in a gap of the power transmission unit 4, and an internal space of the gear accommodation portion 82 can be effectively used to reduce size of the drive apparatus 1.

Note that, in the present preferred embodiment, the third gear 46g meshes with the small-diameter gear 43. Further, a tooth width of the third gear 46g is substantially equal to a tooth width of the small-diameter gear 43. For this reason, the parking gear 51 overlaps not only the third gear 46g but also at least a part of the small-diameter gear 43 when viewed from a direction perpendicular to the axial direction.

As described above, the parking gear 51 is arranged close to the motor 2 side with respect to the first gear 41 in the axial direction. For this reason, the small-diameter gear 43 and the third gear 46g overlapping the parking gear 51 when viewed from a direction orthogonal to the axial direction are also arranged close to the motor 2 in the axial direction. A gear having a largest diameter in the power transmission unit 4 is the third gear 46g. By arranging the third gear 46g close to the motor 2, it is possible to reduce size in the axial direction of a region that is an accommodation space of the power transmission unit 4 and overlaps the third gear 46g when viewed from the axial direction, and to achieve reduction in size of the drive apparatus 1.

As shown in FIG. 3, according to the present preferred embodiment, at least a part of the parking gear 51 overlaps the large-diameter gear 42 when viewed from the axial direction. By the above, a part of the parking mechanism 50 and a part of the power transmission unit 4 can be arranged to overlap each other in the axial direction. According to the present preferred embodiment, it is possible to reduce a projection area of the drive apparatus 1 in the axial direction while sufficiently securing a force for braking rotation of the power transmission unit 4 by the parking mechanism 50 by increasing a diameter of the parking gear 51.

In the present preferred embodiment, the parking gear 51 is provided on an outer peripheral surface of the second shaft 44. The second shaft 44 is a shaft having smallest transmission torque among a plurality of shafts of the power transmission unit 4. By providing the parking gear 51 on the second shaft 44, a reaction force applied to the parking mechanism 50 at the time of locking can be reduced. According to the present preferred embodiment, a reaction force applied to the parking mechanism 50 can be reduced, and the parking mechanism 50 can be downsized.

As shown in FIG. 6, the parking gear 51 of the present preferred embodiment has an annular shape around the central axis J1. The parking gear 51 rotates together with the second shaft 44. That is, the parking gear 51 rotates around the central axis J1 together with the first gear 41 in conjunction with a wheel of a vehicle. A plurality of the tooth portions 51a arranged along the circumferential direction are provided on an outer periphery of the parking gear 51. The tooth portion 51a protrudes to the outside in the radial direction of the central axis J1. In the locked state to be described later, the tooth portion 51a meshes with the protrusion 52a.

The pawl shaft 50t extends along the support axis J4 parallel to the central axis J1. That is, the pawl shaft 50t is a shaft parallel to the second shaft 44. The pawl shaft 50t rotatably supports the parking pawl 52.

The pawl shaft 50t of the present preferred embodiment is orthogonal to the rotary shaft 57. According to the present preferred embodiment, as compared with a case where the rotary shaft 57 and the pawl shaft 50t extend in parallel to each other, it is possible to three-dimensionally arrange the shafts and to achieve reduction in size of the parking mechanism 50 as a whole.

A winding spring 50s is attached to the pawl shaft 50t. The winding spring 50s includes a spring body 50sc having a coil shape, a first leg portion 50sa extending from both end portions of the spring body 50sc, and a second leg portion 50sb.

As shown in FIG. 3, the pawl shaft 50t is inserted into the spring body 50sc. The first leg portion 50sa is in contact with an outer surface of the catch tank 84. On the other hand, as shown in FIG. 6, the second leg portion 50sb is hooked on a spring hooking hole 52h provided in the parking pawl 52. The winding spring 50s applies an elastic force to the parking pawl 52 in a direction in which a distal end is retracted toward the sleeve 56 side.

According to the present preferred embodiment, a part of the catch tank 84 is arranged immediately below the pawl shaft 50t, and comes into contact with the first leg portion 50sa of the winding spring 50s on an outer surface. By the above, the catch tank 84 can support the first leg portion 50sa and apply an elastic force toward a direction to the parking pawl 52 by the winding spring 50s.

Furthermore, as compared with a case where a portion for supporting the first leg portion 50sa is separately prepared in the housing 6, cost required for processing the housing 6 can be reduced by using an outer surface of the catch tank 84.

Note that the position where the first leg portion 50sa of the winding spring 50s is hooked on the outer surface of the catch tank 84 is an example. The first leg portion 50sa may be hooked at any position on the outer surface of the catch tank 84, and may be, for example, further on the upper side than the pawl shaft 50t.

As shown in FIG. 6, the parking pawl 52 is arranged on a side portion of the parking gear 51. The parking pawl 52 includes a proximal end portion 52d, a parking pawl body portion 52b extending obliquely downward from the proximal end portion 52d, the cam contact portion 52c, and the protrusion 52a.

The parking pawl body portion 52b is arranged between the parking gear 51 and the sleeve 56 when viewed from the axial direction of the central axis J1. The protrusion 52a is provided on a surface facing the parking gear 51 side of the parking pawl body portion 52b. On the other hand, the cam contact portion 52c is provided on a surface facing the sleeve 56 side of the parking pawl body portion 52b. The cam contact portion 52c is located in a distal end portion of the parking pawl 52. The protrusion 52a is located between the proximal end portion 52d and the cam contact portion 52c in the length direction of the parking pawl 52.

A support hole 52k around the support axis J4 is provided in the proximal end portion 52d of the parking pawl 52. The pawl shaft 50t is inserted into the support hole 52k. By the above, the parking pawl 52 is supported by the pawl shaft 50t at the proximal end portion 52d, and is rotatable around the support axis J4 by the pawl shaft 50t.

The protrusion 52a protrudes from the parking pawl body portion 52b toward the parking gear 51. The protrusion 52a faces the tooth portion 51a of the parking gear 51. When the parking pawl 52 rotationally moves around the pawl shaft 50t, the protrusion 52a moves in a direction of approaching and separating from the parking gear 51.

The parking pawl 52 may take any one of the locked state, the unlocked state, and the standby state. The locked state and the unlocked state are mutually shifted in accordance with operation of the operator. The standby state occurs in a process of shifting from the unlocked state to the locked state when the operator performs operation to shift from the unlocked state to the locked state.

The locked state is a state in which the protrusion 52a meshes with the parking gear 51 to inhibit rotation of the parking gear 51. In the parking mechanism 50 in the locked state, the protrusion 52a is fitted between the tooth portions 51a of the parking gear 51.

The unlocked state is a state in which the protrusion 52a is separated from the parking gear 51 to release the lock and allow rotation of the parking gear 51. In the parking mechanism 50 in the unlocked state, the protrusion 52a retracts to the outside in the radial direction of the central axis J1 from between the tooth portions 51a.

The standby state is a state in which the protrusion 52a is pressed against an outer peripheral surface of the tooth portion 51a of the parking gear 51 to wait for the locked state. In the standby state, when the parking gear 51 rotates and a gap between the tooth portions 51a coincides with the protrusion 52a, the protrusion 52a meshes with the tooth portion 51a and transition is made to the locked state.

The cam contact portion 52c is located inside the sleeve notch portion 56e (see FIG. 7). The parking pawl 52 receives a force from the cam 53 at the cam contact portion 52c and rotates around the support axis J4. That is, the parking pawl 52 operates as the cam 53 moves.

As shown in FIG. 3, the parking pawl 52 of the present preferred embodiment is arranged above the parking gear 51. For this reason, as compared with a case where the parking pawl 52 is arranged in the horizontal direction with respect to the parking gear 51, it is possible to prevent increase in size of the gear accommodation portion 82 in the horizontal direction. Furthermore, according to the present preferred embodiment, positions in the vertical direction of the parking pawl 52 and the parking gear 51 overlap a position in the vertical direction of the third gear 46g. For this reason, it is possible to prevent the parking pawl 52 and the parking gear 51 from greatly protruding in the vertical direction with respect to an upper end position and a lower end position of the third gear 46g. As a result, it is possible to prevent increase in size of the gear accommodation portion 82 in the vertical direction.

According to the present preferred embodiment, the third gear 46g, the catch tank 84, and the transmission unit 50A of the parking mechanism 50 are arranged side by side along the horizontal direction. For this reason, it is possible to prevent the catch tank 84 and the transmission unit 50A from greatly protruding in the vertical direction with respect to an upper end position and a lower end position of the third gear 46g, and to downsize the drive apparatus 1 in the vertical direction.

According to the present preferred embodiment, the first protruding portion 10 of the housing 6 is located above the parking gear 51. According to the present preferred embodiment, a part of the parking mechanism 50 arranged above the parking gear 51 can be accommodated by the first protruding portion 10, and the drive apparatus 1 can be downsized in the vertical direction by efficiently using a region above the parking gear 51.

According to the present preferred embodiment, the parking pawl 52 is arranged on the first side in the axial direction (+Y side) with respect to the transmission unit 50A, and overlaps the first protruding portion 10 when viewed from the axial direction. According to the present preferred embodiment, by arranging the parking pawl 52 and the transmission unit 50A side by side in the axial direction, it is possible to prevent increase in size of the parking mechanism 50 in the vertical direction (Z-axis direction) and a vehicle front-rear direction (X-axis direction). By the above, a projected area as viewed from the axial direction of the drive apparatus 1 can be reduced.

According to the present preferred embodiment, the catch tank 84 is located above the second gear portion 48, and a position in the vertical direction of the parking pawl 52 overlaps a position in the vertical direction of the catch tank 84. For this reason, the parking pawl 52 which is a part of the parking mechanism 50 can be arranged side by side with the catch tank 84 in the horizontal direction. According to the present preferred embodiment, it is possible to prevent the catch tank 84 or the parking mechanism 50 from protruding upward with respect to other members in the gear accommodation portion 82, and to downsize the drive apparatus 1 in the vertical direction.

According to the present preferred embodiment, the catch tank 84 is located above the second gear portion 48, and the transmission unit 50A is located above the first gear 41. For this reason, it is possible to prevent increase in size of the gear accommodation portion 82 in the horizontal direction as compared with a case where the transmission unit 50A is arranged in the horizontal direction with respect to the first gear 41. According to the present preferred embodiment, it is possible to downsize the drive apparatus 1 by effectively using a space above the first gear 41 having a relatively small diameter.

Next, support of the sleeve 56 will be described in detail.

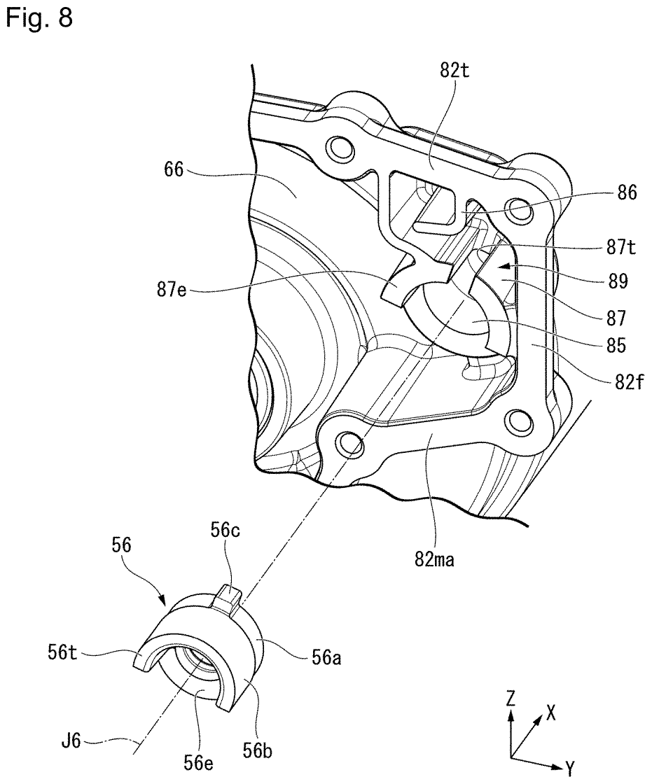

FIG. 8 is an exploded perspective view illustrating the sleeve 56 and a part of the housing 6 that holds the sleeve 56.

The sleeve 56 has an annular portion 56a, an arc portion 56b, and a rotation stop portion 56c. The annular portion 56a has an annular shape around the sleeve axis J6. The annular portion 56a surrounds the distal end 54ca of the cam rod 54 from the outer side in the radial direction of the sleeve axis J6.

As shown in FIG. 8, the arc portion 56b is connected to the second side in the axial direction (−Y side) of the annular portion 56a. The arc portion 56b extends in an arc or substantially arc shape around the sleeve axis J6. A length in the axial direction of the arc portion 56b is larger than a length in the axial direction of the annular portion 56a. The sleeve notch portion 56e is provided in a region surrounded by both end surfaces in the circumferential direction of the arc portion 56b and an end surface on the first side in the axial direction of the annular portion 56a with respect to the sleeve axis J6. The cam rod 54 arranged in the sleeve 56 is exposed to the outside in the radial direction of the sleeve axis J6 at the sleeve notch portion 56e and comes into contact with the parking pawl 52.

The rotation stop portion 56c protrudes to the outside in the radial direction of the sleeve axis J6 with respect to the annular portion 56a. The rotation stop portion 56c is arranged in a region where the arc portion 56b is provided in the circumferential direction around the sleeve axis J6.

In the present preferred embodiment, an outer diameter of the arc portion 56b is larger than an outer diameter of the annular portion 56a. By making the outer diameter of the arc portion 56b larger than the outer diameter of the annular portion 56a, the arc portion 56b can be strongly brought into close contact with a holding surface of the housing 6 when being held by the housing 6. As a result, stability of holding of the sleeve 56 by the housing 6 can be enhanced. Further, the rotation stop portion 56c is provided on an outer peripheral surface of the annular portion 56a. The closer the outer diameter of the annular portion 56a is to an inner diameter of an insertion portion (holding recess 85) of the housing 6, the more difficult it is to attach the annular portion 56a to the housing 6. According to the present preferred embodiment, by making the outer diameter of the annular portion 56a smaller than the outer diameter of the arc portion 56b, positioning of the rotation stop portion 56c and an attachment process to the housing 6 can be facilitated.

In the present preferred embodiment, the dimension in the axial direction of the arc portion 56b is larger than the dimension in the axial direction of the first portion 53a of the cam 53. In a case where the dimension in the axial direction of the arc portion 56b is too short, there is a possibility that the first portion 53a cannot be stably supported in the arc portion 56b when load is applied from the cam 53. According to the present preferred embodiment, by making the arc portion 56b larger than the first portion 53a of the cam 53 in the axial direction, even in a case where load is received from the cam 53, the first portion 53a of the cam 53 can be stably supported in the arc portion 56b.

The partition wall portion 66 of the housing body 6B is provided with the holding recess 85 that holds the sleeve 56, and the sleeve guide portion 87a and the extension wall portion 87e of the first wall portion 87 that protrude from an inner edge of the holding recess 85 to the second side in the axial direction (−Y side).

The holding recess 85 opens to the second side in the axial direction (−Y side) of the central axis J1. That is, the holding recess 85 opens to the gear cover 6C side. The holding recess 85 holds the arc portion 56b of the sleeve 56.

The sleeve guide portion 87a and the extension wall portion 87e of the first wall portion 87 extend in an arc or substantially arc shape around the sleeve axis J6. In the circumferential direction of the sleeve axis J6, a region where the sleeve guide portion 87a and the extension wall portion 87e are provided coincides with a region where the arc portion 56b of the sleeve 56 is provided.

As shown in FIG. 7, the sleeve 56 has a distal end surface 56t facing the second side in the axial direction (−Y side). The distal end surface 56t is covered by the second wall portion 88 of the gear cover 6C from the second side in the axial direction (−Y side). That is, the gear cover 6C is provided with the second wall portion (retaining wall portion) 88 that covers a surface (distal end surface 56t) facing the second side in the axial direction (−Y side) of the sleeve 56.

The sleeve 56 of the present preferred embodiment is inserted into the holding recess 85 provided in the housing body 6B and opened to the first side in the axial direction (+Y side). Further, the distal end surface 56t of the sleeve 56 is covered by the second wall portion 88 of the gear cover 6C from the second side in the axial direction (−Y side). By the above, it is possible to prevent the sleeve 56 from being detached from the holding recess 85. The sleeve 56 of the present preferred embodiment is fixed to the housing 6 by two members (the housing body 6B and the gear cover 6C) constituting the housing 6. According to the present preferred embodiment, the number of parts can be reduced as compared with a case where another member for fixing is provided in the housing 6. Furthermore, since fixing of the sleeve 56 is completed by inserting the sleeve 56 into the holding recess 85 and combining the housing body 6B and the gear cover 6C, an operator who performs assembly can simplify an assembly process as compared with a case where the sleeve 56 is fixed with a fastening member such as a screw.

According to the present preferred embodiment, the second wall portion 88 covering the distal end surface 56t of the sleeve 56 is a part of the first dividing wall portion 89 that partitions the breather chamber R8 inside the gear accommodation portion 82. That is, the second wall portion 88 has a function as a part of the first dividing wall portion 89 and a function as a retaining wall portion. According to the present preferred embodiment, spaces arranged inside the gear accommodation portion 82 can be densely arranged, and the gear accommodation portion 82 can be downsized. In addition, by providing the second wall portion 88 with a plurality of functions, processing cost of the housing 6 can be reduced as compared with a case where wall portions having the functions are provided.

In the present preferred embodiment, the second wall portion 88 covers at least a part of the distal end surface 56t of the sleeve 56. Further, the first wall portion 87 constituting the first dividing wall portion 89 together with the second wall portion 88 surrounds at least a part of the sleeve 56. That is, the sleeve 56 is surrounded and supported by the first wall portion 87 and the second wall portion 88 constituting the first dividing wall portion 89. By the above, the sleeve 56 can be stably supported by the housing 6.

In the present preferred embodiment, the distal end surface 56t of the sleeve 56 is arranged further on the first side in the axial direction (+Y side) than a first mating surface 87f facing the second side in the axial direction (−Y side) of the first wall portion 87. The first mating surface 87f of the first wall portion 87 faces a second mating surface 88f facing the first side in the axial direction (+Y side) of the second wall portion 88 in the axial direction. The first mating surface 87f and the second mating surface 88f are in contact with each other. In a case where the distal end surface 56t of the sleeve 56 is arranged further on the second side in the axial direction (−Y side) than the first mating surface 87f, excessive load may be applied to the sleeve 56 at the time of fastening of the housing body 6B and the gear cover 6C. According to the present preferred embodiment, size of the sleeve 56 in the axial direction is set to a height that does not protrude from the first wall portion 87 in the axial direction, and it is possible to prevent application of excessive load to the sleeve 56.

The sleeve guide portion 87a of the first wall portion 87 is provided with the notch portion 87t. The notch portion 87t opens to the gear cover 6C side in the axial direction. An opening of the notch portion 87t is covered by the second wall portion 88. The notch portion 87t extends with a uniform width along the axial direction of the sleeve axis J6. The width dimension of the notch portion 87t is slightly larger than the width dimension of the rotation stop portion 56c. The rotation stop portion 56c of the sleeve 56 is inserted into the notch portion 87t. As shown in FIG. 7, the notch portion 87t reaches the holding recess 85.

According to the present preferred embodiment, the rotation stop portion 56c of the sleeve 56 is inserted into the notch portion 87t opened to the gear cover 6C side, so that the sleeve 56 in the holding recess 85 can be prevented from rotating about the sleeve axis J6. By the above, the sleeve 56 can be positioned in the circumferential direction around the sleeve axis J6. By the above, an opening direction of the sleeve notch portion 56e provided in the sleeve 56 can be stabilized, and the cam 53 can be reliably exposed to the parking pawl 52.

Note that although the rotation stop portion 56c of the present preferred embodiment is provided on an outer peripheral surface of the annular portion 56a, the configuration of the rotation stop portion 56c is not limited to that in the present preferred embodiment. The rotation stop portion 56c only needs to protrude to the outside in the radial direction from the annular portion 56a, and may be provided on an outer peripheral surface of the arc portion 56b, for example. Further, the rotation stop portion 56c may have an end portion on the outer side in the radial direction located further on the outer side in the radial direction than an outer peripheral surface of the annular portion 56a.

As shown in FIG. 7, a second protruding portion (protruding portion) 82g protruding to the first side in the axial direction is provided on a surface facing the first side in the axial direction (+Y side) of the housing body 6B. The second protruding portion 82g of the present preferred embodiment is provided on a surface facing the first side in the axial direction of the partition wall portion 66. The second protruding portion 82g has a circular or substantially circular shape when viewed from the axial direction. Further, the second protruding portion 82g overlaps the holding recess 85 when viewed from the axial direction. A second accommodation space (accommodation space) 82h is provided inside the second protruding portion 82g. The second accommodation space 82h is a recess provided in a surface facing the second side in the axial direction (−Y side) of the partition wall portion 66. The second protruding portion 82g is provided on a bottom portion of the holding recess 85. The second protruding portion 82g can accommodate the distal end 54ca of the cam rod 54.

According to the present preferred embodiment, the partition wall portion 66 of the housing body 6B protrudes to the first side in the axial direction to accommodate the distal end 54ca of the cam rod 54. By the above, the parking mechanism 50 can be arranged close to the motor 2 side inside the housing 6 while an operation stroke of the cam rod 54 is secured. As a result, the entire drive apparatus 1 can be downsized in the axial direction. Furthermore, in order to secure a stroke of the cam rod 54, only a part of the partition wall portion 66 is partially protruded to the first side in the axial direction (+Y side), so that an outer shape of the housing 6 can be downsized as compared with a case where the entire partition wall portion 66 is arranged on the first side in the axial direction.

As shown in FIG. 3, in the present preferred embodiment, the sleeve 56 is arranged further on the vehicle front side (+X side, a first side in the horizontal direction) than the differential axis J3, the intermediate axis J2, and the central axis J1. Further, the sleeve 56 is arranged above the differential axis J3, the intermediate axis J2, and the central axis J1. The fluid O inside the gear accommodation portion 82 is mainly moved up by the third gear 46g rotating around the differential axis J3, and is supplementarily moved up by the second gear portion 48 rotating around the intermediate axis J2. According to the present preferred embodiment, by arranging the sleeve 56 as described above, the sleeve 56 can be most separated from the third gear 46g and can also be separated from the second gear portion 48 accordingly. Further, the sleeve 56 of the present preferred embodiment is supported by the first dividing wall portion 89 surrounding an opening of the breather 8, and thus is located in the vicinity of the breather 8. As a result, the breather 8 can be separated from the third gear 46g and the second gear portion 48, and the fluid O can be prevented from reaching the opening of the breather 8.

As described above, the sleeve 56 is located on the vehicle front side (+X side) and the upper side (+Z side) with respect to the differential axis J3, the intermediate axis J2, and the central axis J1. For this reason, no gear of the power transmission unit 4 is arranged immediately below the sleeve 56. According to the present preferred embodiment, a region 82ma immediately below the sleeve 56 of the bottom portion 82m is located above the differential axis J3, the intermediate axis J2, and the central axis J1. For this reason, it is possible to prevent a space in which nothing is accommodated from being provided immediately below the sleeve 56 inside the gear accommodation portion 82, and to downsize the drive apparatus 1. Further, by arranging the bottom portion 82m of the gear accommodation portion 82 partially on the upper side, a liquid level of the fluid O in the gear accommodation portion 82 can be easily increased, and the fluid O can be efficiently moved up by each gear of the power transmission unit 4. Further, a part of the fluid O scattered as the fluid O is moved up by each gear reaches the sleeve 56 to lubricate the sleeve 56 and reduce sliding resistance with respect to the cam 53. Note that, since the opening of the breather 8 is arranged in a space partitioned by the first dividing wall portion 89 and the second dividing wall portion 86, the scattered fluid O hardly reaches the opening.

As indicated by an imaginary line (two-dot chain line) in FIG. 3, the housing 6 may be provided with a supply path 6f extending from the catch tank 84 to the sleeve 56. The supply path 6f is, for example, a through hole extending from the catch tank 84 to the holding recess 85 that holds the sleeve 56. Further, a part of the supply path 6f may include a rib protruding from the partition wall portion 66 to the internal space side of the gear accommodation portion 82. In this case, the fluid O flowing out from the catch tank 84 reaches the sleeve 56 along the upper side of the rib. The fluid O supplied to the sleeve 56 reduces sliding resistance between the sleeve 56 and the cam 53.

While various embodiments and variations of the present invention are described above, it will be understood that configurations, a combination of the configurations, and the like according to each of the embodiments and the variations are only illustrative, and that an addition, elimination, and substitution of a configuration(s), and other modifications can be made without departing from the spirit of the present invention. Further, the present invention is not limited by the embodiment.

For example, in the above-described embodiment, the case where the holding recess that holds the sleeve is provided in the housing body, and the retaining wall portion that covers a distal end surface of the sleeve is provided in the gear cover is described. However, the holding recess may be provided in the gear cover, and the retaining wall portion may be provided in the housing body.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A drive apparatus comprising:
a motor that rotates about a central axis;
a power transmission unit that transmits power of the motor;
a parking mechanism; and
a housing having a gear accommodation portion that accommodates the power transmission unit and the parking mechanism,
wherein
the power transmission unit includes at least one shaft,
the parking mechanism includes:
a parking gear provided on an outer peripheral surface of the shaft;
a parking pawl provided with a protrusion that meshes with the parking gear;
a transmission unit that transmits power to the parking pawl; and
a sleeve having a tubular shape,
the transmission unit includes:
a cam rod that drives along an axial direction of the central axis; and
a cam attached to the cam rod to operate the parking pawl,
the cam is guided by the sleeve,
the gear accommodation portion is provided with:
a breather that allows inside and outside of the gear accommodation portion to communicate with each other; and
a dividing wall portion that partitions a space in which the breather opens inside the gear accommodation portion,
the gear accommodation portion includes:
a first housing member; and
a second housing member arranged on a first side in the axial direction of the first housing member and connected to the first housing member,
the second housing member is provided with a holding recess that opens to the first side in the axial direction and holds the sleeve,
the first housing member is provided with a retaining wall portion covering a surface facing a second side in the axial direction of the sleeve, and
the retaining wall portion is a part of the dividing wall portion.

2. The drive apparatus according to claim 1, wherein
the dividing wall portion includes a first wall portion that is a part of the second housing member and a second wall portion that is a part of the first housing member,
at least a part of an outer peripheral surface of the sleeve is surrounded by the first wall portion, and
at least a part of an end surface facing the second side in the axial direction of the sleeve is covered by the second wall portion.

3. The drive apparatus according to claim 2, wherein
the sleeve includes:
an annular portion around a sleeve axis; and
a rotation stop portion protruding to outside in a radial direction of the sleeve axis with respect to the annular portion, and
the first wall portion is provided with a notch portion into which the rotation stop portion is inserted.

4. The drive apparatus according to claim 3, wherein
the sleeve has an arc portion connected to the second side in the axial direction of the annular portion and extending in an arc shape around the sleeve axis, and
an outer diameter of the arc portion is larger than an outer diameter of the annular portion.

5. The drive apparatus according to claim 4, wherein
the cam has a first portion and a second portion having a circular cross section and arranged coaxially,
the second portion is located on a distal end side of the cam rod with respect to the first portion,
an outer diameter of the second portion is smaller than an outer diameter of the first portion, and
a dimension in the axial direction of the arc portion is larger than a dimension in the axial direction of the first portion.

6. The drive apparatus according to claim 1, wherein
a surface facing the first side in the axial direction of the second housing member is provided with a protruding portion that overlaps the holding recess when viewed from the axial direction and protrudes to the first side in the axial direction, and
an accommodation space capable of accommodating a distal end portion of the cam rod is provided inside the protruding portion.

7. The drive apparatus according to claim 1, wherein
the power transmission unit includes:
the shaft that rotates around the central axis;
a first gear provided on an outer peripheral surface of the shaft;
a second gear portion that includes a large-diameter gear meshed with the first gear and a small-diameter gear having a diameter smaller than that of the large-diameter gear and rotating around an intermediate axis together with the large-diameter gear; and
a differential gear that includes a third gear meshing with the small-diameter gear and rotating around a differential axis,
a catch tank that opens to an upper side is arranged inside the gear accommodation portion,
the parking gear is provided on an outer peripheral surface of the shaft, and
the third gear, the catch tank, and the transmission unit are arranged side by side along a horizontal direction.

8. The drive apparatus according to claim 7, wherein
the catch tank is located above the second gear portion, and
the transmission unit is located above the first gear.

9. The drive apparatus according to claim 7, wherein
the housing is provided with a supply path extending from the catch tank to the sleeve.

10. The drive apparatus according to claim 7, wherein
the sleeve is arranged further on a first side in a horizontal direction than the differential axis, the intermediate axis, and the central axis, and
the sleeve is arranged above the differential axis, the intermediate axis, and the central axis.

11. The drive apparatus according to claim 10, wherein
the gear accommodation portion has a bottom portion covering an internal space from below, and
a region immediately below the sleeve on the bottom portion is located above the differential axis, the intermediate axis, and the central axis.

12. The drive apparatus according to claim 1, wherein
a catch tank that opens to an upper side is arranged inside the gear accommodation portion,
the parking mechanism includes:
a pawl shaft rotatably supporting the parking pawl; and
a winding spring mounted on the pawl shaft, and
the winding spring includes:
a first leg portion in contact with an outer surface of the catch tank; and
a second leg portion hooked on the parking pawl.
